(19) United States
(12) Patent Application Publication
(10) Pub. No.: US 2024/0422099 A1
(43) Pub. Date: Dec. 19, 2024

(54) COMMUNICATION APPARATUS, COMMUNICATION METHOD AND PROGRAM

(71) Applicant: NIPPON TELEGRAPH AND TELEPHONE CORPORATION, Tokyo (JP)

(72) Inventors: Hisashi KOJIMA, Tokyo (JP); Takafumi HAMANO, Tokyo (JP); Shingo OKADA, Tokyo (JP); Yukihiro TOGARI, Tokyo (JP)

(21) Appl. No.: 18/707,003

(22) PCT Filed: Dec. 3, 2021
(86) PCT No.: PCT/JP2021/044554

§ 371 Date: May 2, 2024

(51) Int. Cl. H04L 45/745; H04L 12/46

(52) U.S. Cl. CPC H04L 45/745; H04L 12/4633; H04L 2212/00

(57) ABSTRACT

A communication device that accommodates a computer connecting to a LAN in a core network improves economical efficiency at the time of consolidating an overlay network for each area by including: a determination unit that is configured to determine an area to which a transmission source of a first packet belongs on the basis of a destination of a second packet once the second packet is received, the first packet being designated to the computer from any one of a plurality of areas, the second packet being obtained by encapsulating the first packet with a destination of any one of a plurality of IP addresses allocated to the communication device for the respective areas; a first transmission unit that is configured to transmit the second packet to the computer on the basis of the destination of the second packet; and a second transmission unit that is configured to encapsulate a response from the computer in a third packet with a destination of an IP address of a representative router of the area determined by the determination unit and transmit the third packet.

### TECHNICAL FIELD

The present invention relates to a communication device, a communication method, and a program.

### BACKGROUND ART

As a technology capable of accommodating a large number of IoT devices in a VPN without depending on an access network, an “End-to-End overlay network” has been proposed (Non Patent Literature 1). Although SD-WAN has been commercialized as a conventional VPN technology based on overlay, there is a problem in scalability such as the number of tunnels (the number of connections) of a VPN when a very large number of IoT devices are to be connected. In an “End-to-End overlay network”, each IoT device is not directly accommodated in the base on the cloud side, but each IoT device is accommodated in a geographically distributed area representative router, and the accommodation places of the VPN tunnel are distributed, thereby improving scalability.

If a basic configuration of an IoT service connecting IoT devices to the cloud is assumed, and it is attempted to connect them (the IoT devices and the cloud) via a VPN, a VPN tunnel is to be established between terminating devices (customer premises equipment (CPE)) on the IoT device side and a terminating device (vCPE) on the cloud side. In a case where a significantly large number of IoT devices are connected to the cloud, the vCPE that is a terminating device on the cloud side is required to terminate VPN tunnels from a number of CPEs on the IoT device side, which may cause a bottleneck in terms of performance with a high probability. On the other hand, in an “End-to-End overlay network”, the problem regarding the number of tunnels of the vCPE is solved by arranging a plurality of area representative routers, terminating tunnels from the CPEs on the side of IoT devices belonging to the corresponding areas by the area representative routers, and aggregating the tunnels between the area representative routers and the vCPE (cloud) on the cloud side.

On the other hand, in the above-described “End-to-End overlay network”, Segment Routing for IPv6 (SRv6) is used as a technology for realizing a VPN tunnel (Non Patent Literature 2). SRv6 is a technology that realizes source routing by listing a route through which a packet is desired to pass as a segment ID (SID) list in a segment routing header (SRH) defined as an extension header of IPv6. Furthermore, not only an IP address of a node that allows a packet to pass therethrough but also processing at a node that has received the packet can be described as the SID in SRv6. This is called network programming (Non Patent Literature 3). In the above-described “End-to-End overlay network”, the VPN is realized by utilizing the network programming function at an end point while reducing the state held in the network by utilizing the SRv6 technology and thereby separating routing for each tenant (each user).

### CITATION LIST

### Non Patent Literature

Non Patent Literature 1: Togari et al., “A Study of End-to-End Overlay Networks”, The Institute of Electronics, Information and Communication Engineers, Society Convention B7-1, September 2021
Non Patent Literature 2: “Segment Routing Architecture”, IETF RFC8402, [online], Internet <URL: https://tools.ietf.org/html/rfc8402>
Non Patent Literature 3: “Segment Routing over IPv6 (SRv6) Network Programming”, IETF RFC8986, [online], Internet <URL: https://tools.ietf.org/html/rfc8986>

### SUMMARY OF INVENTION

### Technical Problem

In the “End-to-End overlay network” proposed in Non Patent Literature 1, tunnels between vCPEs that are terminating devices on a cloud side and area representative routers are consolidated to prevent the number of tunnels held by the vCPEs from depending on the number of IoT devices. This reduces a load of the vCPEs. Although communication from the cloud side to the IoT devices passes through the area representative routers, communication is consolidated to one tunnel between each vCPE and each area representative router by adopting a one-to-one relationship between the vCPE and the area representative router on the cloud side.

On the other hand, the area representative routers are assumed to be installed in units called “areas”, and application to geographically divided regions is also taken into consideration in addition to carriers and types of access networks for the areas. Also, since the number of IoT devices (the number of CPEs) that can be accommodated in one area representative router is limited in terms of performance, it is necessary to arrange a large number of area representative routers (that is, split areas into a large number of areas) in a system in which a significantly large number of IoT devices are connected.

Therefore, if it is attempted to apply the “End-to-End overlay network” throughout Japan, the number of areas is assumed to be several tens to 100 or more. In this case, it becomes necessary to install several tens to 100 or more vCPEs in one-to-one relationships with the area representative routers. It is necessary to activate the vCPEs corresponding to the number of areas in a time zone in which the amount of traffic is significantly small, such as when a service is started, during the night, or in the early morning. Although the vCPEs are assumed to be implemented as virtual routers such as VMs or containers, a large amount of computing resources is continuously consumed regardless of the small amount of traffic, which is not economically efficient.

The present invention was made in view of the above points, and an object thereof is to improve economical efficiency at the time of consolidating an overlay network for each area.

### Solution to Problem

Thus, in order to solve the above problem, a communication device that accommodates a computer connecting to a LAN in a core network includes: a determination unit that is configured to determine an area to which a transmission source of a first packet belongs on the basis of a destination of a second packet once the second packet is received, the first packet being designated to the computer from any one of a plurality of areas, the second packet being obtained by encapsulating the first packet with a destination of any one of a plurality of IP addresses allocated to the communication device for the respective areas; a first transmission unit that is configured to transmit the second packet to the computer on the basis of the destination of the second packet; and a second transmission unit that is configured to encapsulate a response from the computer in a third packet with a destination of an IP address of a representative router of the area determined by the determination unit and transmit the third packet.

### Advantageous Effects of Invention

It is possible to improve economical efficiency at the time of consolidating an overlay network for each area.

### BRIEF DESCRIPTION OF DRAWINGS

FIG. 1 is a diagram illustrating a configuration example of a communication system according to an embodiment of the present invention.

FIG. 2 is a diagram illustrating a hardware configuration example of a computer that functions as a VCPE 70 according to the embodiment of the present invention.

FIG. 3 is a diagram illustrating a functional configuration example of a CPE 50.

FIG. 4 is a diagram illustrating a functional configuration example of the vCPE 70.

FIG. 5 is a diagram illustrating a functional configuration example of an area representative router (AR 40).

FIG. 6 is a diagram illustrating a configuration example of a routing table 54 of each CPE 50.

FIG. 7 is a diagram illustrating a configuration example of a routing table of the vCPE 70.

FIG. 8 is a diagram illustrating a configuration example of a connection information table 75 of the vCPE 70.

FIG. 9 is a diagram illustrating a configuration example of a routing table of the area representative router (AR 40).

FIG. 10 is a diagram illustrating a functional configuration example of a controller 30.

FIG. 11 is a diagram illustrating a configuration example of an EID-RLOC database 33.

FIG. 12 is a sequence diagram for explaining connection to the AR 40 of the CPE 50 (CPE 50-11) and registration in the controller 30 of the vCPE 70, which are executed prior to communication.

FIG. 13 is a sequence diagram for explaining an example of a processing procedure performed when a packet is transmitted from a host 60-11 under control of the CPE 50-11 toward a host 60-3 under control of the vCPE 70.

FIG. 14 is a sequence diagram for explaining a flow of communication from the host 60-3 to the host 60-11.

FIG. 15 is a flowchart for explaining an example of a processing procedure executed when an area to which the CPE 50-11 belongs changes.

FIG. 16 is a flowchart for explaining an example of a processing procedure executed when the area to which the CPE 50-11 belongs changes.

FIG. 17 is a diagram illustrating an example of a change in each routing table when the area to which the CPE 50-11 belongs changes.

FIG. 18 is a diagram for explaining scale-in/scale-out of the vCPE 70.

### DESCRIPTION OF EMBODIMENTS

Hereinafter, embodiments of the present invention will be described with reference to the drawings.

### [Overview of Present Embodiment]

In the present embodiment, it is assumed that traffic of a plurality of areas can be accommodated in one virtualized CPE (vCPE).

Specifically, a plurality of IP addresses (routing locators (RLOCs)) are allocated to one vCPE for each area. When a packet is transmitted from customer premises equipment (CPE) on an IoT device side to a vCPE on a cloud side, a destination address (RLOC) of the packet encapsulated in SRv6 is changed for each area to which the CPE belongs, so that it is possible for the vCPE that has received the packet to determine which area the packet is from. The vCPE that has received the packet from the CPE identifies the area of the packet on the basis of the RLOC of the destination and stores a relationship between connection and the area. This enables the vCPE to determine to which area the packet is to be transmitted when the vCPE receives a reply packet from an application on the cloud and enables transfer to an area representative router that is in charge of the area.

This enables a single vCPE to transmit and receive packets of a plurality of areas and enables scale-in/scale-out of the vCPE in accordance with the traffic amount. On the other hand, although the number of tunnels held by the VCPE, which is one for a specific area representative router in Non Patent Literature 1, increases to the number of tunnels corresponding to the number of areas accommodated in the vCPE, the number of areas assumed to be several tens to a hundred is considered to be a range which does not cause any problem in terms of performance.

### [System Configuration of Present Embodiment]

In the present embodiment, an IP address held by a terminal or an application as a communication destination is used as an endpoint ID (EID), and segment routing for IPv6 (SRv6) is used as a means for encapsulating and transmitting an IP packet between CPEs or vCPEs connecting (accommodating) a base (data center) of each device or the cloud to a core network. The core network is only required to be compatible with IPv6. However, a protocol for encapsulation between the CPEs or the vCPEs is not limited to SRv6 and may be substituted by another means that can encapsulate an IP packet.

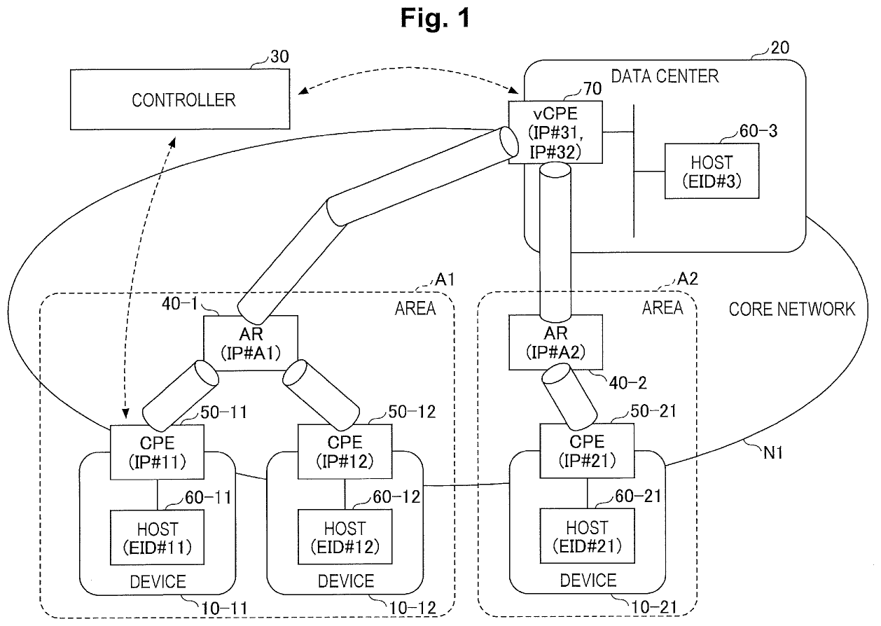

FIG. 1 is a diagram illustrating a configuration example of a communication system according to the embodiment of the present invention. In FIG. 1, a plurality of devices 10 (a device 10-11, a device 10-12, and a device 10-21) and a data center 20 are connected to a core network N1. Each device 10 is connected to the core network N1 via a CPE 50 which is a terminating device. A LAN in the data center 20 is connected to (accommodated in) the core network N1 via a vCPE 70 which is a virtual terminating device. A host 60 which is a computer is under control of each of the CPE 50 and the vCPE 70, and each host 60 is connected to the LAN in the device 10 or the data center 20.

The CPE 50 of each of the devices 10 belongs to one area and is connected to an AR 40, which is an area representative router for managing the area, via the SRv6 tunnel. In addition, a controller 30 is disposed at a place accessible from the CPEs 50 via the core network N1.

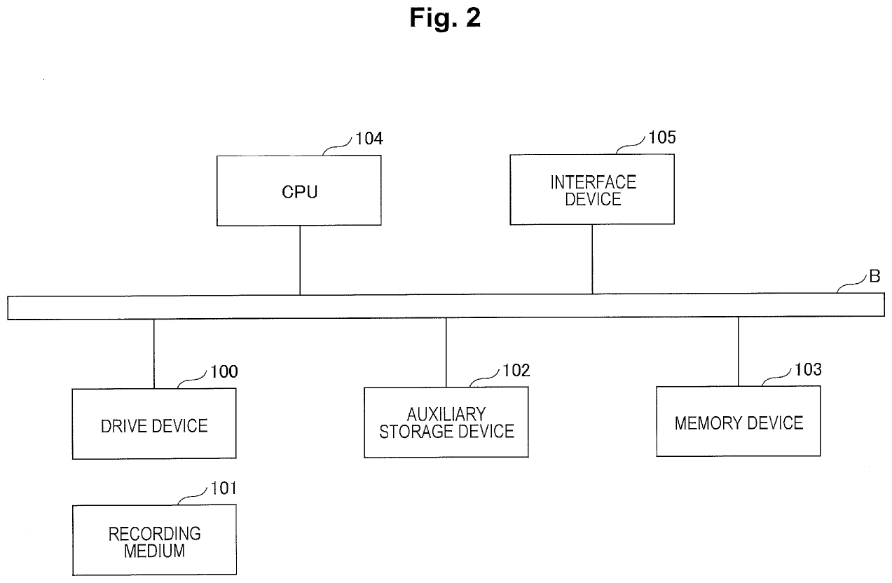

In FIG. 1, the character sequences indicating IP addresses of devices or hosts 60 are shown in parentheses. The character sequences starting with “IP” are IP addresses (RLOC) of the CPEs 50, the vCPE 70, or the ARs 40 and are addresses having reachability via the core network N1. Communication via the core network N1 is encapsulated with these IP addresses. Meanwhile, the character sequences starting with “EID” are IP addresses assigned to the hosts 60 or applications existing in the LAN under control of the CPEs 50 or the vCPE 70. EIDs are fixedly assigned and do not change even when the devices 10 move or the network to which the devices 10 are connected changes (that is, the EIDs do not depend on the positions of the devices 10). The applications can always continue to communicate with these EIDs. Note that in the present embodiment, communication is performed between a host 60 that is a computer on the side of a device 10 and a host 60-3 that is a computer on the side of a data center 20.

[Hardware configuration of device 10 and the like] FIG. 2 is a diagram illustrating a hardware configuration example of a computer that functions as a vCPE 70 according to the embodiment of the present invention. The computer functioning as the vCPE 70 includes a drive device 100, an auxiliary storage device 102, a memory device 103, a CPU 104, an interface device 105, and the like, which are connected to each other via a bus B.

A program implementing processing on the computer is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores files, data, and the like which are required.

In a case where an instruction to start the program is received, the memory device 103 reads and stores the program from the auxiliary storage device 102. The CPU 104 executes a function related to the computer according to the program stored in the memory device 103. The interface device 105 is used as an interface for connecting to a network.

Note that the device 10, the controller 30, the ARs 40, and the like may also have hardware configurations similar to that in FIG. 2.

### [Functional Configuration of Each Device]

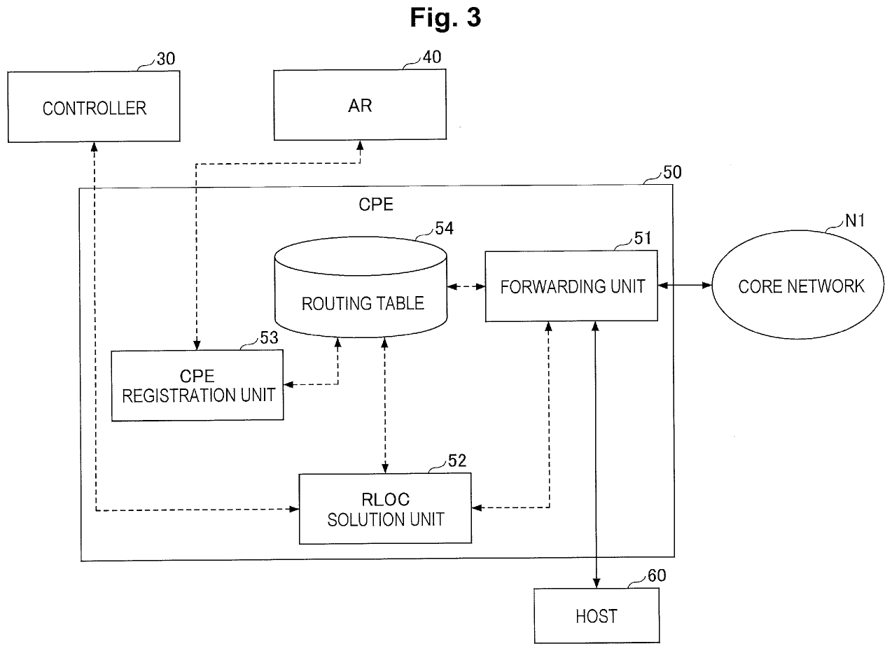

FIG. 3 is a diagram illustrating a functional configuration example of the CPEs 50. In FIG. 3, the CPE 50 includes a forwarding unit 51, an RLOC solution unit 52, and a CPE registration unit 53. Each of these units is implemented by processing executed by processing that one or more programs installed in the device 10 cause the CPU of the device 10 to execute. The CPE 50 also utilizes a routing table 54. A routing table 54 can be implemented by using, for example, a memory device or an auxiliary storage device of the device 10.

The forwarding unit 51 encapsulates a packet from the host 60 under control of the CPE 50 to the data center 20 and transmits the packet to the core network N1, and when an encapsulated packet from the data center 20 or the like to the host 60 under control of the CPE 50 is received from the core network N1, the forwarding unit 51 decapsulates the packet and delivers the decapsulated packet to the host 60. In the present embodiment, since SRv6 is used as an encapsulation protocol, the forwarding unit 51 of the CPE 50 performs encapsulation and decapsulation of SRv6.

The routing table 54 is a storage unit that holds a path table necessary for the forwarding unit 51 to perform packet forwarding, packet encapsulation, and packet decapsulation. A specific example of the routing table 54 will be described later.

When the forwarding unit 51 transmits a packet, the RLOC solution unit 52 solves an RLOC corresponding to a destination EID in a case where the RLOC corresponding to the destination EID is not registered in the routing table 54. Specifically, the RLOC solution unit 52 inquires of the controller 30 about the RLOC corresponding to the destination EID, and when the RLOC solution unit 52 acquires the RLOC as a response to the inquiry, the RLOC solution unit 52 registers the correspondence between the destination EID and the RLOC (correspondence information between the destination EID and the RLOC) in the routing table 54.

When the CPE 50 is activated, the CPE registration unit 53 notifies the area representative router (AR 40) designated in advance of the IP address (RLOC) of the CPE 50 itself and the EID under control of the CPE 50. The CPE registration unit 53 also receives an area ID from the AR 40 as a response to the notification of the RLOC and the EID, and registers information for enabling an encapsulated packet from the AR 40 to be received (decapsulated) in the routing table 54. Note that the area ID is area identification information.

Although the present embodiment employs a form in which the CPE 50 itself directly notifies the AR 40 of the RLOC and the EID, the AR 40 may be notified via a controller or the like that manages the AR 40.

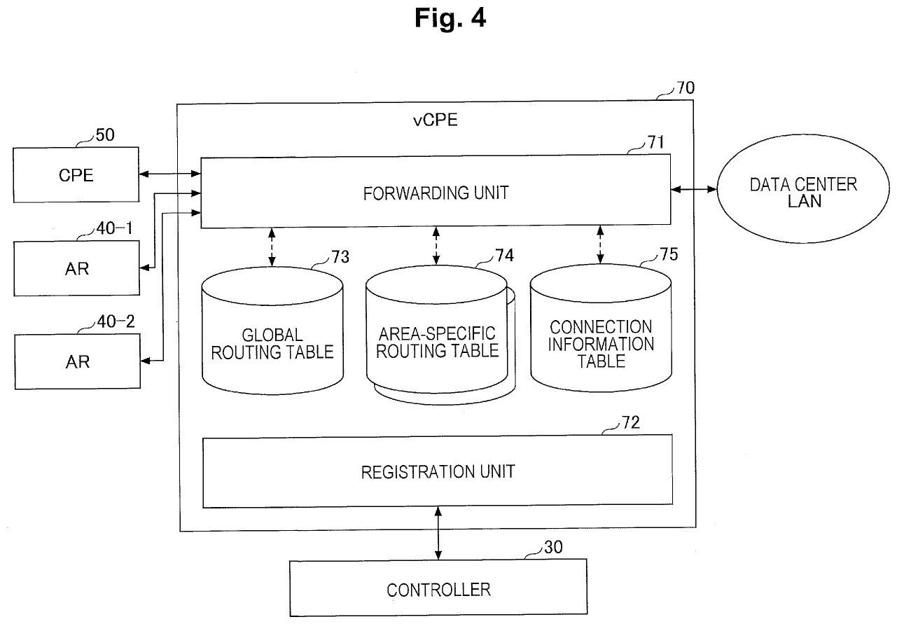

FIG. 4 is a diagram illustrating a functional configuration example of the vCPE 70. In FIG. 4, the vCPE 70 includes a forwarding unit 71 and a registration unit 72. Each of these units is implemented by processing that one or more programs installed in the computer functioning as the vCPE 70 cause the CPU 104 to execute. The vCPE 70 also uses a global routing table 73, an area-specific routing table 74, and a connection information table 75. Each of these tables can be implemented by using of, for example, the memory device 103, an auxiliary storage device 102 or the like.

The forwarding unit 71 decapsulates the SRv6-encapsulated packet transmitted from the CPE 50 and transmits (transfers) the packet to the LAN in the data center 20. The forwarding unit 71 encapsulates a packet received from the host 60v connected to the LAN in the data center 20 and transmits (transfers) the packet to the appropriate AR 40.

When the vCPE 70 is activated, the registration unit 72 notifies the controller 30 of an IP address (RLOC) for each area allocated to the vCPE 70 and an EID under control of the vCPE 70.

The global routing table 73 is a routing table that holds path information necessary for the vCPE 70 to communicate with the core network N1. The area-specific routing table 74 is a routing table that holds path information for encapsulating a packet transmitted from an application in the LAN of the data center 20 and transmitting the packet to the appropriate AR 40, and is defined for each area. Specific configuration of them will be described later.

The connection information table 75 is a table for determining connection of a packet transmitted from an application under control of the CPE 50 and temporarily holding correspondence information between connection and an area only while communication related to the connection is continued. In the present embodiment, although the transmission source EID and the destination EID are used for connection determination, information such as 5tuples including a port number of TCP or UDP may be used.

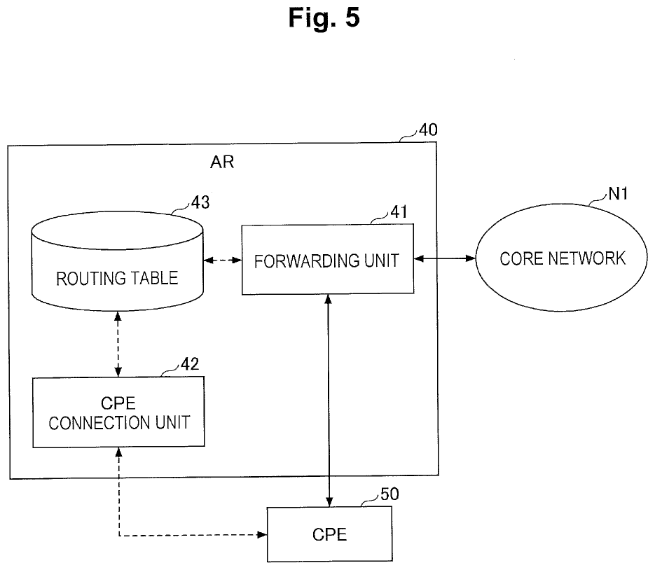

FIG. 5 is a diagram illustrating a functional configuration example of an area representative router (AR 40). In FIG. 5, the AR 40 includes a forwarding unit 41 and a CPE connection unit 42. Each of these units is implemented by processing executed by processing that one or more programs installed in the AR 40 cause the CPU of the AR 40 to execute. The AR 40 also utilizes the routing table 43. The routing table 43 can be implemented by using, for example, the memory device or the auxiliary storage device of the AR 40.

The forwarding unit 41 decapsulates a packet from the data center 20, searches for the routing table 43 using the destination EID of the original IP packet (EID under control of the CPE 50 as a destination) as a key, and acquires the RLOC of the CPE 50 corresponding to the destination EID. Thereafter, the forwarding unit 41 re-encapsulates the original packet with the RLOC and transmits (transfers) the re-encapsulated packet to the CPE 50 as the destination. Note that although the AR 40 may not be involved in communication in the direction from the CPEs 50 to the vCPE 70 (the direction from the device 10 to the data center 20), the AR 40 may have a role of transferring an IPv6 packet encapsulated by SRv6 or the like as a normal router. In this case, the forwarding unit 41 has a standard IPv6 transfer function.

The CPE connection unit 42 executes processing for connecting one of the CPEs 50 when receiving a connection request from the CPE 50. Specifically, the CPE connection unit 42 receives the IP address (RLOC) and the EID of the CPE 50 included in the connection request from the CPE 50, and registers, in the routing table 43 of the AR 40, path information to be encapsulated with the corresponding RLOC and transmitted to the EID of the CPE 50 is registered. Thereafter, the CPE connection unit 42 notifies the CPE 50 of the area ID of the area controlled by the host AR 40 as a connection response. As a result, the forwarding unit 41 can deliver a packet transmitted from the cloud side to one of the CPEs 50 as a destination.

Note that, instead of a form in which the connection request from the CPE 50 is directly received from the CPE 50, a form in which a controller or the like receives the connection request from the CPE 50 and the CPE connection unit 42 receives the connection request from the controller may be adopted.

The routing table 43 is a storage unit that holds a path table necessary for the forwarding unit 41 to perform packet forwarding, packet encapsulation, and packet decapsulation. A specific example of the routing table 43 will be described later.

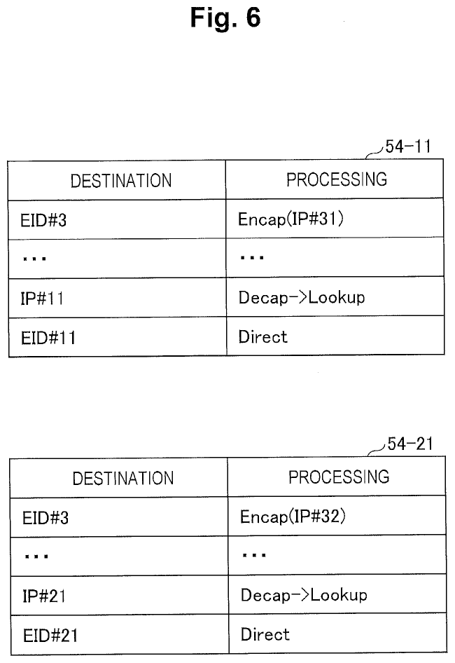

FIG. 6 is a diagram illustrating a configuration example of the routing tables 54 of each CPE 50. FIG. 6 illustrates a specific example of the routing tables 54 in the case of the network configuration example in FIG. 1. A routing table 54-11 is a routing table of a CPE 50-11, and a routing table 54-12 is a routing table of a CPE 50-12.

The routing table 54 of each CPE 50 includes a destination address (destination prefix) and corresponding processing content. The forwarding unit 51 searches for the routing table 54 using the destination address of a received IP packet as a key, and performs processing described in the record A specific description will be given on the basis of an example of the routing table 54-11 of the CPE 50-11.

The record of “Destination=EID #3, Processing=Encap (IP #31)” is used when the CPE 50-11 on the device 10 side communicates with the vCPE 70 (RLOC: IP #31). “EID #3” in the destination field is an address used by the host 60 or an application on the cloud side, and in a case where the destination address of a packet received by the CPE 50-11 corresponds to this, the forwarding unit 51 executes processing of “Encap (IP #31)”. “Encap (IP #31)” indicates that the packet is encapsulated by SRv6 with the destination IP address set as IP #31 and is then transmitted. In other words, the forwarding unit 51 encapsulates the packet received by the CPE 50-11 from the host 60 under control of the CPE 50-11 with IP #31, which is one RLOC of the vCPE 70 having reachability in the core network N1, and transmits the packet. The routing table 54 of the CPE 50 holds such a record for each host 60 on the cloud side as destination of communication.

The record of “Destination=IP #11, Processing=Decap->Lookup” indicates that, in a case where the destination IP address is “IP #11”, the packet is decapsulated (Decap) and the routing table 54-11 is searched for again (Lookup). Since IP #11 is the IP address (RLOC) of the CPE 50-11, this record indicates processing of “decapsulating a (encapsulated) packet directed to the CPE 50-11 itself and searching for the routing table 54-11 again”.

The record of “Destination=EID #11, Processing=Direct” indicates that, in a case where the destination address of an IP packet is “EID #11”, the IP packet is directly delivered. Directly delivering the IP packet means that the destination address exists in the same LAN and the IP packet is directly transmitted to the destination. This record is used to enable direct deriver in a case where the destination is the host 60 under control of the CPE 50-11 itself when the routing table 54-11 is searched for again as a result of the above-described “Destination=IP #11, Processing=Decap->Lookup”.

The routing table 54-21 of the CPE 50-21 is substantially similar to the routing table 54-11 of the CPE 50-11 other than that “processing=Encap (IP #32)” is set for “destination=EID #3”. The vCPE 70 holds a plurality of RLOCs in order to determine an area, and IP #32 which is the RLOC of the vCPE 70 for the area 2 is transmitted from the CPE 50-21 belonging to the area 2 as a destination. In addition, since the RLOC of the CPE 50-21 is IP #21 and the EID under control of the CPE 50-21 is EID #21, the “destinations” of the third and fourth records are different from those in the routing table 54-11 of the CPE 50-11.

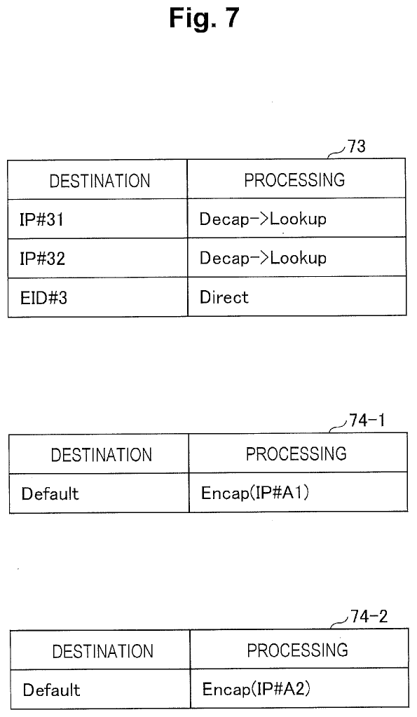

FIG. 7 is a diagram illustrating a configuration example of the routing tables of the vCPE 70. FIG. 7 illustrates a specific example of the routing table of the VCPE 70 that connects the LAN in the data center 20 of FIG. 1 to the core network N1. Note that although the vCPE 70 accommodates a plurality of areas, a different RLOC is held for each area for determination thereof. In the present embodiment, the IP #31 is the RLOC for the area 1, and the IP #32 is the RLOC for the area 2.

The global routing table 73 of the vCPE 70 holds path information necessary for the vCPE 70 to communicate with the core network N1. The record of “Destination=IP #31, Processing=Decap->Lookup” indicates that in a case where a packet directed to IP #31, that is, directed to the vCPE 70 (for the area 1) is received, the packet is decapsulated (Decap), and the routing table is searched for again. In other words, the record is a record for decapsulating the SRv6 packet transmitted from the CPE 50 to the vCPE 70. Although the same applies to the record of “Destination=IP #32”, the IP #32 and the IP #31 have different corresponding areas as described above, and path information therefor is thus separately described. The processing content is similar to the processing for the area 1.

The record of “Destination=EID #3, Processing=Direct” indicates that in a case where the destination of an IP packet is “EID #3”, the IP packet is directly delivered. The record is a record for enabling a packet directed to the host 60-3 (that is, directed to the EID #3) in the LAN of the data center 20 under control of the vCPE 70 to be directly delivered at the time of searching for Decap->Lookup, which is processing of the first record or the second record, again.

The area-specific routing table 74 of the vCPE 70 is a routing table that is referred to when the vCPE 70 receives a packet (a packet reply from the CPE 50) from the host 60-3 in the LAN of the data center 20. The area-specific routing table 74 is divided for each area accommodated by the vCPE 70, and an appropriate table is referred to when transmission is performed from the vCPE 70 to the area representative router (AR 40). A mechanism for determining which table is to be referred to will be described later. In each area-specific routing table 74, only one record (one route) of a default route is described. The processing field is different for each area. An area 1 routing table 74-1, which is an area-specific routing table 74 for the area 1, describes processing of performing encapsulation by SRv6 directed to the IP address (IP #A1) of the AR 40-1, which is the area representative router of the area 1 and transmitting it. An area 2 routing table 74-2, which is an area-specific routing table 74 for the area 2, describes processing of performing encapsulation by SRv6 directed to the IP address (IP #A2) of the AR 40-2, which is the area representative router of the area 2 and transmitting it.

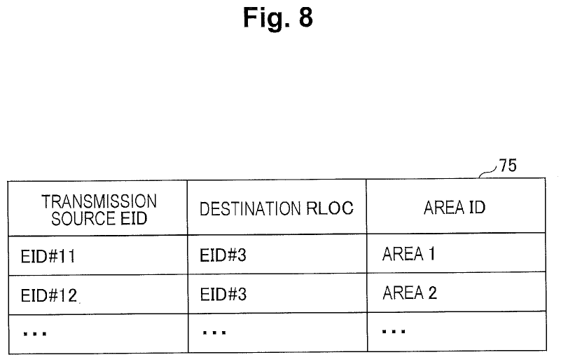

FIG. 8 is a diagram illustrating a configuration example of a connection information table 75 of the vCPE 70. Each record of the connection information table 75 includes a transmission source EID, a destination EID, and an area ID. The transmission source EID and the destination EID are information for identifying packet connection. The connection indicates correspondence between a packet transmitted from an application under control of the CPE 50 and a reply packet as a response thereto from an application under control of the vCPE 70, and is identified by the combination of the transmission source EID and the destination EID in the present embodiment. However, the connection may be identified by using another identifiers in a packet header, such as a port number or a protocol identifier, or the connection may be identified by a combination thereof.

The area ID is information indicating to which area the CPE 50, transmission from which the connection identified by the pair of the transmission source EID and the destination EID corresponds to, belongs. Although the VCPE 70 holds a different RLOC for each area, the vCPE 70 identifies an area by using a destination IP address of the SRv6 header before decapsulation, that is, an RLOC such as IP #31 or IP #32 when the vCPE 70 receives the SRv6 packet from the CPE 50. In the present embodiment, a packet transmitted to IP #31 is identified as a packet from the area 1, and a packet transmitted to the IP #32 is identified as a packet from the area 2.

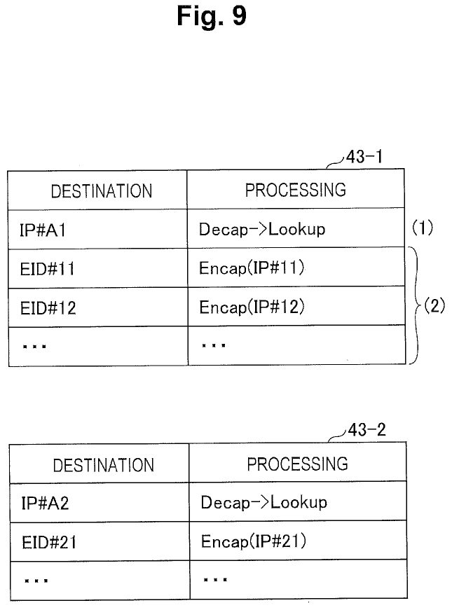

FIG. 9 is a diagram illustrating a configuration example of the routing tables 43 of the area representative router (the AR 40). A specific description will be given on the basis of an example of a routing table 43-1 of the AR 40-1.

“Destination=IP #A1, Processing=Decap->Lookup” of the first record (row (1)) indicates that a packet directed to itself (directed to IP #A1) transmitted from the VCPE 70 is decapsulated once the packet is received, and the routing table 43-1 is searched for again.

“Destination=EID #11, Processing=Encap (IP #11)” of the second record indicates that in a case where the destination is EID #11, that is, the EID under control of the CPE 50-11, the packet is encapsulated with IP #11, which is the RLOC of the CPE 50-11 and is transmitted.

Similarly, the third record indicates that a packet directed to the EID (IP #12) under control of the CPE 50-12 is encapsulated with IP #12, which is the RLOC of the CPE 50-12, and is transmitted. The processing (processing of row (2)) is performed on a decapsulated packet as a result of the processing of the first record (row (1)). The same applies to a routing table 43-2 of the AR 40-2.

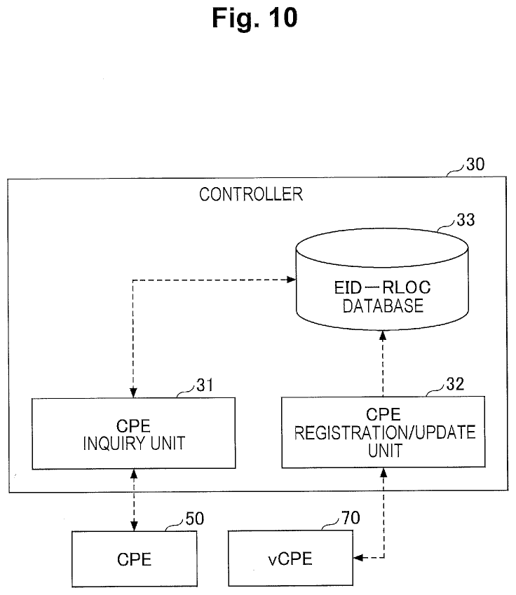

FIG. 10 is a diagram illustrating a functional configuration example of the controller 30. In FIG. 10, the controller 30 includes a CPE inquiry unit 31 and a CPE registration/update unit 32. Each of these units is implemented by processing that one or more programs installed in the controller 30 cause the CPU of the controller 30 to execute. The controller 30 also utilizes an EID-RLOC database 33. The EID-RLOC database 33 can be implemented by using, for example, a memory device or an auxiliary storage device of the controller 30.

The EID-RLOC database 33 is a storage unit that stores a correspondence between EIDs allocated under control of the CPEs 50 or the vCPE 70 and RLOCs currently allocated to the CPEs 50 or the vCPE 70. In the present embodiment, only the correspondence between the EID and the RLOC of the vCPE 70 is registered in the EID-RLOC database 33. The configuration of the EID-RLOC database 33 will be described later.

The CPE inquiry unit 31 searches for the EID-RLOC database 33 in response to an inquiry about an RLOC corresponding to an EID from one of the CPEs 50 and responds with the RLOC corresponding to the EID. An area ID is registered in each entry of the EID-RLOC database 33, and the CPE inquiry unit 31 returns the RLOC of the area to which the CPE 50 as an inquiry source belongs.

The CPE registration/update unit 32 newly registers and updates the EID-RLOC correspondence registered in the EID-RLOC database 33. Specifically, in a case where a vCPE 70 is newly connected to the network, the CPE registration/update unit 32 newly adds a record to the EID-RLOC database 33.

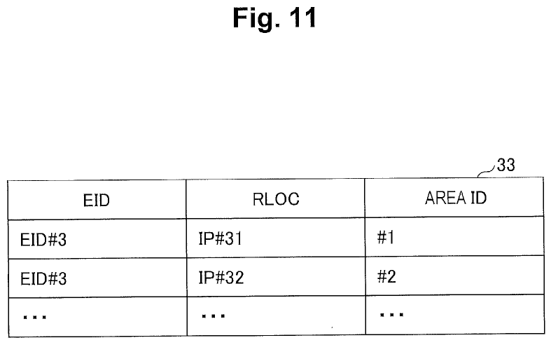

FIG. 11 is a diagram illustrating a configuration example of the EID-RLOC database 33. The EID-RLOC database 33 also holds an area ID of an area to which each RLOC corresponds in addition to the correspondence between the EID and the RLOC of the vCPE 70. FIG. 11 illustrates an example of the EID-RLOC database 33 corresponding to FIG. 1.

Although only information regarding the vCPE 70 is held in the EID-RLOC database 33 in the present embodiment as described above, a plurality of records are present for one vCPE 70 in the EID-RLOC database 33 since one vCPE 70 holds a different RLOC for each area. “RLOC=IP #31” of the first record indicates the RLOC corresponding to the area 1, and “RLOC=IP #32” of the second record indicates the RLOC corresponding to the area 2. In a case where the vCPE 70 accommodates more areas, records of different RLOCs and area IDs are added for the same EID. Note that since the EID-RLOC correspondence of the CPEs 50 (the CPE 50-11, the CPE 50-12, and the CPE 50-21 in FIG. 1) on the device 10 side is held in the routing tables 43 (FIG. 9) of the area representative routers AR40, the EID-RLOC correspondence is not held in the EID-RLOC database 33.

### [Processing Procedure]

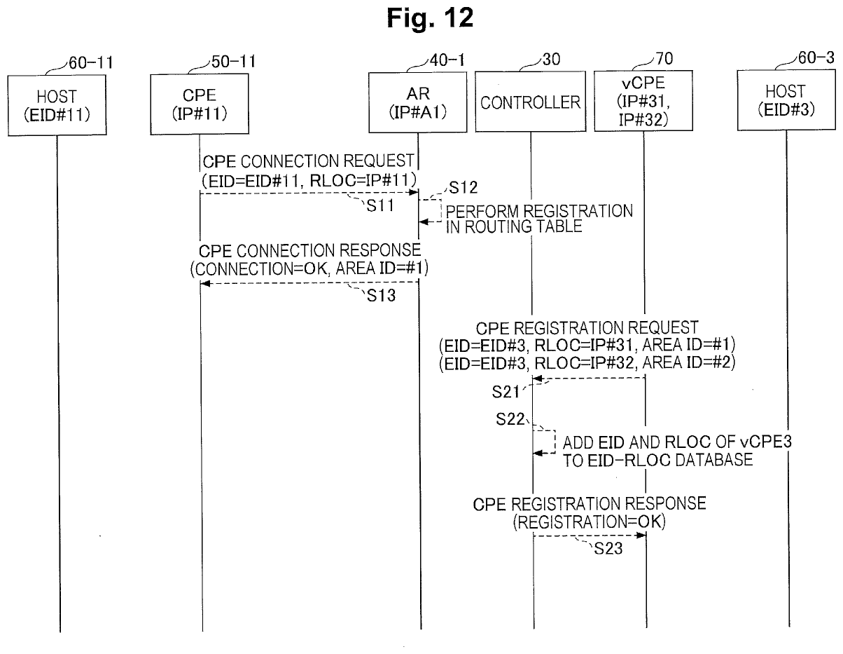

Hereinafter, processing procedures executed in the communication system in FIG. 1 will be described. FIG. 12 is a sequence diagram for explaining connection of one of the CPEs 50 (CPE 50-11) to one of the ARs 40 and registration in the controller 30 of the vCPE 70, which are executed prior to communication.

First, a processing procedure performed when the CPE 50 (the CPE 50-11) is connected to the AR 40 will be described.

When the CPE 50-11 is connected to the network and an IP address (RLOC) is assigned thereto, the CPE registration unit 53 of the CPE 50-11 transmits a CPE connection request to the nearest (the area to which the CPE 50-11 belongs) AR 40 (in this case, the AR 40-1) (S11). The CPE connection request includes the EID (EID #11) allocated under control of the CPE 50-11 and the RLOC (IP #11) assigned by the network. Note that the RLOC of the CPE 50-11 is a global IP address or the like dispensed from the network to which the CPE 50-11 is connected. In addition, it is assumed that the EID under control of the CPE 50 is set in the CPE 50 in advance.

When the CPE connection request from the CPE 50-11 is received, the CPE connection unit 42 of the AR 40-1 registers information necessary for packet transfer from the AR 40-1 to the CPE 50-11 in the routing table 43-1 of the AR 40-1 (S12). In this case, information of “Destination=EID #11, Processing=Encap (IP #11)” is registered (see FIG. 9). This indicates that when the AR 40-1 receives a packet with a destination IP address of EID #11, that is, a packet directed to the host 60 under control of the CPE 50-11, the packet is encapsulated with the destination address=IP #11, that is, the IP address of the RLOC of the CPE 50-11 and is then transmitted.

Subsequently, the CPE connection unit 42 of the AR 40-1 transmits a CPE connection response (Connection=OK, Area ID=#1) to the CPE 50-11 (S13). When the CPE registration unit 53 of the CPE 50-11 receives the CPE connection response, the CPE 50-11 recognizes that the area ID of the area to which the CPE 50-11 belongs is #1.

Next, a processing procedure performed when information on the vCPE 70 is registered in the controller 30 will be described.

After activation of the vCPE 70, the registration unit 72 of the vCPE 70 transmits a CPE registration request to the controller 30 (S21). The CPE registration request includes, for each area accommodated by the vCPE 70, an EID (EID #3) under control of the vCPE 70, an RLOC corresponding to the area in the vCPE 70, and an area ID of the area. In the present embodiment, since the vCPE 70 accommodates the area 1 and the area 2, the CPE registration request includes (EID=EID #3, RLOC=IP #31, Area ID=#1) for the area 1 and (EID=EID #3, RLOC=IP #32, Area ID=#2) for the area 2. Note that the RLOC of the vCPE 70 is also assumed to be a global IP address similarly to the RLOC of the CPE 50-11. Although various methods are assumed for dispensing of an IP address in the cloud environment, the present embodiment does not depend on a dispensing method. It is only necessary that a global IP address that can reach the vCPE 70 from the outside be assigned as a result.

When the CPE registration request from the vCPE 70 is received, the CPE registration/update unit 32 of the controller 30 registers information included in the CPE registration request in the information regarding the vCPE 70 in the EID-RLOC database 33 of itself (S22). In this case, two records “EID=EID #3, RLOC=IP #31, Area ID=#1” and “EID=EID #3, RLOC=IP #32, Area ID=#2” are registered in the EID-RLOC database 33 (see FIG. 11). Subsequently, the CPE registration/update unit 32 transmits a CPE registration response (registration=OK) to the vCPE 70 (S23).

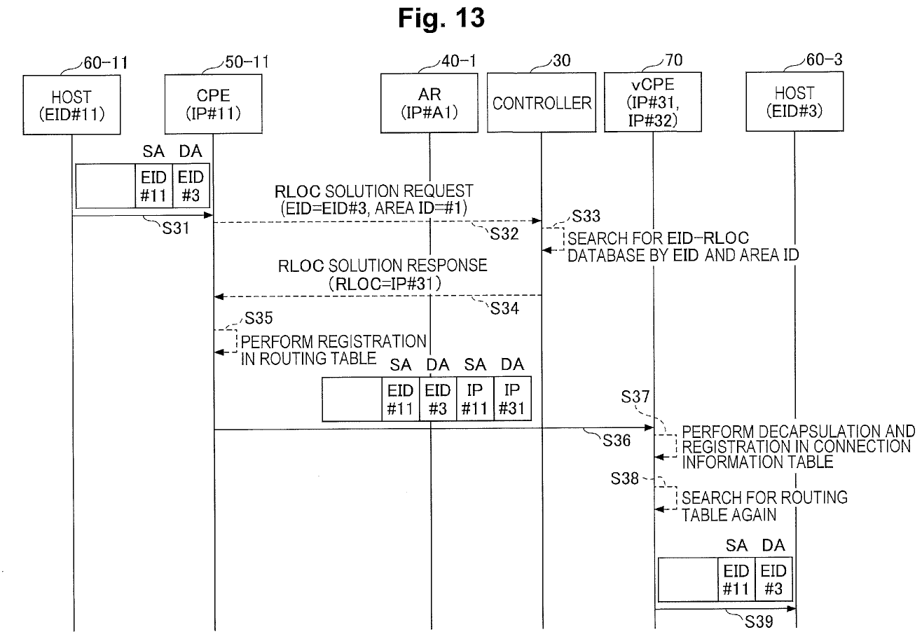

FIG. 13 is a sequence diagram for explaining an example of a processing procedure performed when a packet is transmitted from a host 60-11 under control of the CPE 50-11 to a host 60-3 under control of the vCPE 70.

The host 60-11 transmits a packet toward the host 60-3 (S31). At this time, the host 60-11 recognizes EID #11, which is its own EID, as its own IP address and assigns EID #11 to the transmission source address of the packet (denoted as SA in FIG. 13), and recognizes EID #3 of the host 60-3 as the IP address of the host 60-3 and assigns EID #3 to the destination address of the packet (denoted as DA in FIG. 13). In other words, the host 60-11 and the host 60-3 operate by simply recognizing the EIDs as the IP addresses. Therefore, each host 60 is only required to operate as a normal IP host and does not need a function specific to the present embodiment.

When the forwarding unit 51 of the CPE 50-11 receives the packet from the host 60-11, the RLOC solution unit 52 transmits an RLOC solution request to the controller 30 because the destination EID of the packet is not described in the routing table 54-11 (S32). The RLOC solution request includes EID #3, which is the destination address of the packet received from the host 60-11 and #1 which is the area ID to which the CPE 50-11 itself belongs.

When the RLOC solution request from the CPE 50-11 is received, the CPE inquiry unit 31 of the controller 30 searches for the EID-RLOC database 33 using the EID=EID #3 and the area ID=#1 included in the RLOC solution request as keys (S33). As a result of the search, it is found that the RLOC corresponding to the EID=EID #3 and the area ID=#1 is IP #31, which is the RLOC of the vCPE 70. Note that this record is registered in the controller 30 by the vCPE 70 in S21 to S23.

Subsequently, the CPE inquiry unit 31 transmits an RLOC solution response (RLOC=IP #31) to the RLOC solution unit 52 of the CPE 50-11 (S34).

When the RLOC solution response is received, the RLOC solution unit 52 of the CPE 50-11 registers “Destination=EID #3, Processing=Encap (IP #31)” in the routing table 54-11 of the CPE 50-11 (S35) (see the routing table 54-11 in FIG. 6). This indicates that when a packet with a destination address of EID #3 is received, the packet is encapsulated with the destination=IP #31 (since EID #3 is present under control of the vCPE 70 and the RLOC of the VCPE 70 is IP #31) and is then transmitted.

Subsequently, the forwarding unit 51 of the CPE 50-11 refers to the routing table 54-11, encapsulates the packet received from the host 60-11 with the destination address=IP #31 and the transmission source address=IP #11 (RLOC of the CPE 50-11 itself) and transmits the packet toward the vCPE 70 (S36).

When the packet from the CPE 50-11 is received, the forwarding unit 71 of the vCPE 70 processes the packet on the basis of the global routing table 73 (see FIG. 7). Here, since the packet (encapsulated packet) has the destination address=IP #31, the forwarding unit 71 executes corresponding processing=Decap->Lookup. In other words, the forwarding unit 71 first decapsulates the packet on the basis of “Decap” and registers the connection information in the connection information table 75 (FIG. 8) of the vCPE 70 (S37). Specifically, the forwarding unit 71 registers the pair of the transmission source EID=EID #11 and the destination EID=EID #3 after the decapsulation and the area (area 1) identified from the destination address (IP #31) before the decapsulation in the connection information table 75 of the vCPE 70 to which the forwarding unit itself belongs. However, in a case where there is already a corresponding record, the registration is not performed. Note that the connection information registered in the connection information table 75 times out and is deleted from the connection information table 75 in a case where the corresponding communication is not performed for a certain period of time.

Subsequently, the forwarding unit 71 searches for the routing table 54-31 again on the basis of “Lookup” (S38). Since the destination address of the packet (the decapsulated packet) at the time of performing the search again is EID #3, corresponding processing is “Direct”. Therefore, the forwarding unit 71 directly delivers the packet to the host 60 with the EID #3 (S39). As a result, the host 60-3 receives the packet from the vCPE 70.

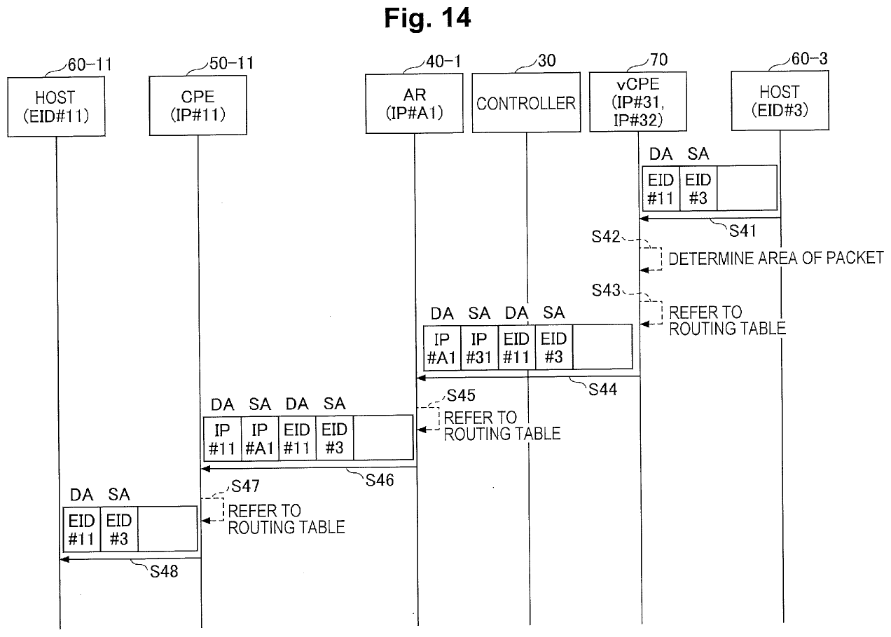

FIG. 14 is a sequence diagram for explaining a flow of communication from the host 60-3 to the host 60-11. This communication is communication of a reply (response) of communication from the host 60-11 to the host 60-3 in FIG. 13.

In step S41, the host 60-3 transmits a packet (hereinafter, the packet is referred to as a “target packet”) toward the host 60-11 (S41). At this time, the destination address of the target packet is set to EID #11, which is the EID of the host 60-11, and the transmission source address of the target packet is set to EID #3, which is the EID of the host 60-3.

When the forwarding unit 71 of the vCPE 70 receives the target packet from the host 60-3, the forwarding unit 71 then refers to the connection information table 75 (FIG. 8) of the vCPE 70 itself, checks whether the target packet is a response packet to a packet from the host 60-3 to the host 60-11, and then acquires the area ID of the target packet (S42). Specifically, the forwarding unit 71 searches for a record with (the destination EID, the transmission source address) switched from the destination and the transmission source in the connection information table 75 compared to the pair of the (transmission source address, the destination address) of the target packet. Since the destination address of the target packet is EID #11, and the transmission source address is EID #3 in this case, the transmission source EID=EID #11 and the destination EID=EID #3 of the first record in the connection information table 75 (FIG. 8) match. It is possible to ascertain that since the area ID of the record is the area 1, the target packet is to be transmitted to the area 1.

Subsequently, the forwarding unit 71 refers to the area 1 routing table 74-1 (FIG. 7) in order to transmit the target packet to the AR 40-1 which is the area representative router of the area 1 (S43). Since only a default route of the destination=Default is registered in the area 1 routing table 74-1, the forwarding unit 71 performs processing=Encap (IP #A1) with reference to the default route. In other words, the forwarding unit 71 encapsulates the target packet by SRv6, then sets the destination address to IP #A1, and transmits the encapsulated target packet to the AR40-1 (S44).

When the encapsulated target packet is received from the vCPE 70, the forwarding unit 41 of the AR 40-1 refers to the routing table 43-1 (see FIG. 9) (S45). Since the destination address of the encapsulated target packet is IP #A1, which is the RLOC of the AR 40-1 itself, the record of “Destination=IP #A1, Processing=Decap->Lookup” in the routing table 43-1 corresponds to the target packet. Thus, the forwarding unit 41 decapsulates the encapsulated target packet and searches for the routing table 43-1 again. The destination address of the decapsulated packet is EID #11 and thus corresponds to “Destination=EID #11, Processing=Encap (IP #11)” in the routing table 43-1. Therefore, the forwarding unit 41 sets the destination address of the target packet to IP #11, encapsulates the target packet, and then transmits the target packet to the CPE 50-11 (RLOC=IP #11) (S46).

When the encapsulated target packet is received from the AR 40-1, the forwarding unit 51 of the CPE 50-11 refers to the routing table 54-11 (S47). Specifically, the forwarding unit 51 searches for the routing table 54-11 of the CPE 50-11 using the destination address of the encapsulated target packet=IP #11 (RLOC of the CPE 50-11, that is, directed to the own device) as a key. Since the target packet corresponds to the record of “Destination=IP #11, Processing=Decap->Lookup”, the forwarding unit 51 decapsulates the encapsulated target packet and searches for the routing table 54-11 again. The destination address of the decapsulated target packet is EID #11 and thus corresponds to the record of “Destination=EID #11, Processing=Direct”. Therefore, the forwarding unit 51 directly delivers the target packet to EID #11, that is, to the host 60-11 (S48). As a result, the host 60-11 receives the target packet.

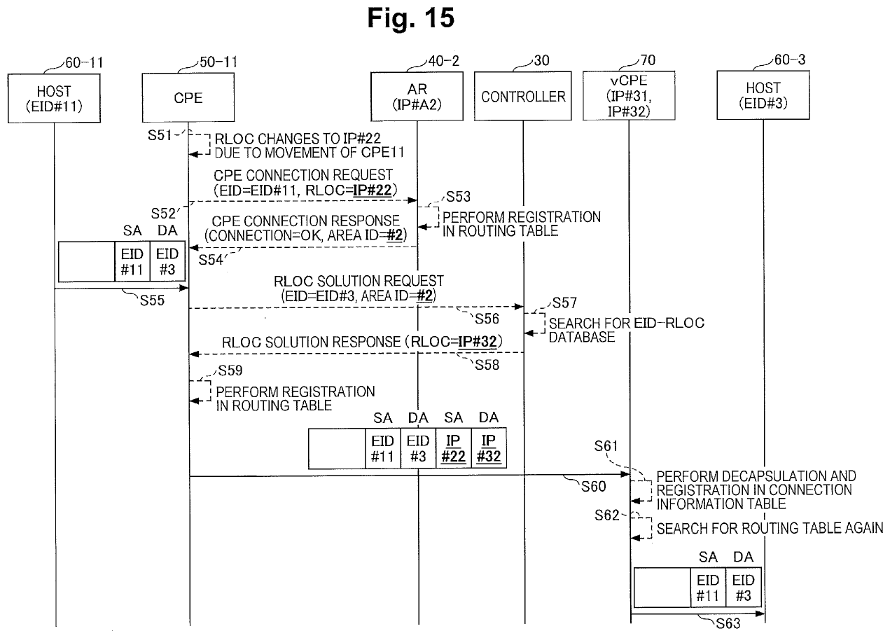

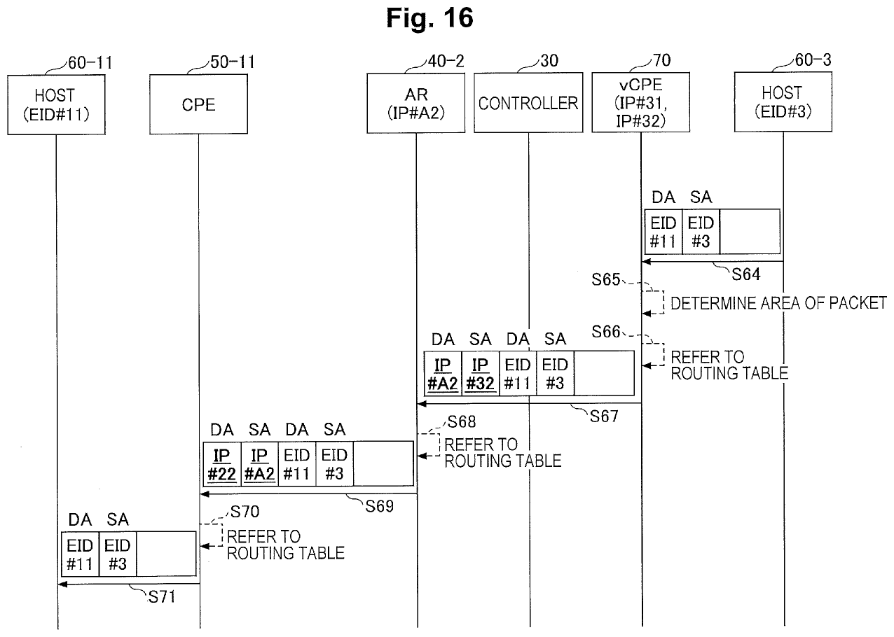

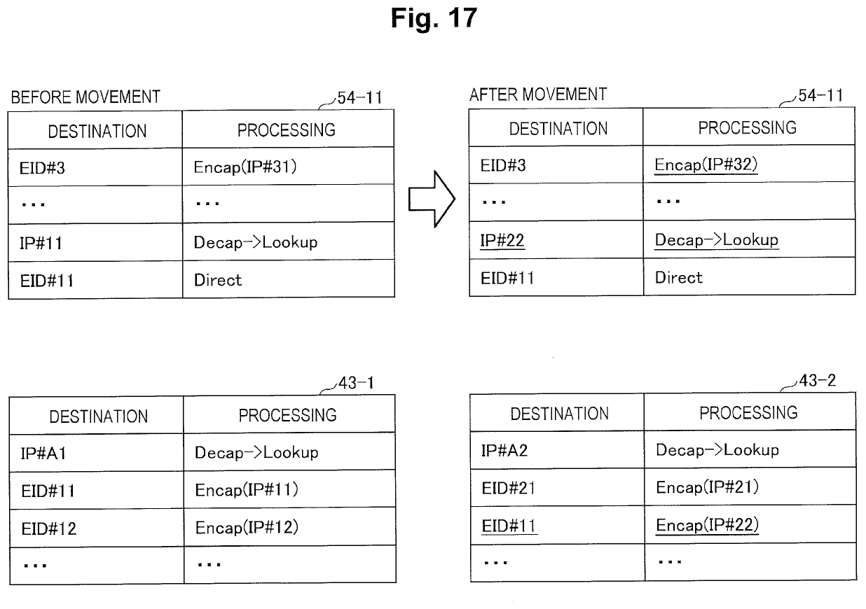

Next, a processing procedure executed when the CPE 50-11 moves from a position under control of the AR 40-1 to a position under control of the AR 40-2 will be described with reference to FIGS. 15 to 17. FIGS. 15 and 16 are sequence diagrams, and FIG. 17 is a diagram illustrating a change in the routing table of the CPE 50-11 and the routing tables of the AR 40-1 and the AR 40-2.

When the CPE 50-11 (the device 10-11 including the CPE 50-11) moves from the position under control of the AR 40-1 to the position under control of the AR 40-2, the CPE 50-11 reconnects to the access network, and the IP address dispensed from the network, that is, the RLOC of the CPE 50-11 is changed (S51). In this example, it is assumed that the RLOC of the CPE 50-11 has been changed from IP #11 to IP #22. Therefore, the CPE registration unit 53 of the CPE 50-11 changes the record of “Destination=IP #11, Processing=Decap->Lookup” to “Destination=IP #22, Processing=Decap->Lookup” in the routing table 54-11 of the CPE 50-11 (see FIG. 17). Note that this record is for performing processing of decapsulating a packet and searching for the routing table 54-11 again in a case where the packet is transmitted from the AR 40 to the CPE 50-11 and the packet is directed to the CPE 50-11 itself (to the RLOC of the CPE 50-11).

Once the CPE 50-11 is connected to the network, the CPE registration unit 53 transmits a CPE connection request to the nearest AR 40 (in this case, the AR 40-2) (S52). The CPE connection request includes the EID=EID #11 and the RLOC=IP #22. Although the EID is not changed from that before the movement, the RLOC is IP #22, which is the newly dispensed IP address as described above.

When the CPE connection request from the CPE 50-11 is received, the CPE connection unit 42 of the AR 40-2 registers a record for transmitting a packet to the CPE 50-11 in the routing table 43-2 (S53). Specifically, the CPE connection unit 42 registers a record of “Destination=EID #11, Processing=Encap (IP #22)” in the routing table 43-2 of the AR 40-2 in FIG. 17. This record indicates processing of encapsulating a packet with a destination address of EID #11 under control of the CPE 50-11 with IP #22, which is the new RLOC of the CPE 50-11, and transmitting the packet.

When the CPE connection unit 42 of the AR 40-2 has successfully performed normal registration in the routing table 43-2, the CPE connection unit 42 transmits a CPE registration response to the CPE 50-11 (S54). The CPE registration response includes the area ID=#2 as the area ID of the area to which the AR 40-2 belongs.

As described above, the connection procedure performed when the CPE 50-11 moves from the position under control of the AR 40-1 to the position under control of the AR 40-2 is completed.

Note that the information before the movement of the CPE 50-11 (Destination=EID #11, Processing=Encap (IP #11)) registered in the routing table 43-1 of the AR 40-1 is deleted by the CPE connection unit 42 of the CPE 50-11 because the information is no longer necessary in the future. As a deletion method, a timeout may occur when a state in which no packets arrive at the CPE 50-11 continues for a certain period of time (if a specific entry of the routing table 43-1 is not referred to for a certain period of time, the entry is deleted), or the CPE 50-11, the AR 40-2, or the like may explicitly notify the AR 40-1 of the fact that the movement of the CPE 50-11 has been completed, and the CPE connection unit 42 of the CPE 50-11 may delete unnecessary information in the routing table 43-1 of the AR 40-1.

Next, a flow of a packet from the host 60-11 to the host 60-3 will be described.

The host 60-11 transmits a packet to the host 60-3 (S55).

When the forwarding unit 51 of the CPE 50-11 receives the packet, the RLOC solution unit 52 of the CPE 50-11 transmits an RLOC solution request to the controller 30 in order to acquire the RLOC corresponding to EID #3, which is the destination address of the packet (S56). The RLOC solution request includes the EID=#3, which is an EID to be solved, and the area ID=#2, which is the ID of the area to which the CPE 50-11 belongs.

When the RLOC solution request is received, the CPE inquiry unit 31 of the controller 30 searches for the EID-RLOC database 33 using the EID (EID #3) and the area ID (#2) included in the RLOC solution request as keys (S57). In the EID-RLOC database 33 (FIG. 11), IP #32 (RLOC for the area 2 of the vCPE 70) is registered as the RLOC corresponding to the EID=EID #3 and the area ID=#2, and the CPE inquiry unit 31 thus transmits an RLOC solution response including the RLOC=IP #32 (S58). Note that when the CPE 50-11 is connected under control of the AR 40-1, the area ID is #1, and the RLOC=IP #31 is returned, while in a case where the CPE 50-11 is under control of the AR 40-2, the area ID=#2, and the RLOC=IP #32 is thus returned. With this mechanism, the vCPE 70 receives a packet having a different encapsulated destination address depending on the area to which the CPE 50 belongs, and can thus determine the area to which the response packet is transmitted as described above.

When the RLOC solution response from the controller 30 is received, the RLOC solution unit 52 of the CPE 50-11 can solve the RLOC=IP #32 as the RLOC corresponding to the EID=EID #3, and thus registers a record of “Destination=EID #3, Processing=Encap (IP #32)” in the routing table 54-11 (S59). The record means that a packet directed to EID #3 is encapsulated with the destination address of IP #32 and the packet is transmitted to IP #32 (that is, the vCPE 70).

When the registration in the routing table 54-11 is completed, the forwarding unit 51 of the CPE 50-11 transmits the packet encapsulated with the destination address=IP #32 toward the vCPE 70 (S60).

When the packet is received, the forwarding unit 71 of the vCPE 70 refers to the global routing table 73 (S61). The packet corresponds to “Destination=IP #32, Processing=Decap->Lookup” in the global routing table 73 of the vCPE 70 in FIG. 7. This record means processing of decapsulating a packet directed to IP #32 (that is, to the vCPE 70 itself) when the packet is received and searching for the global routing table 73 again.

Thus, the forwarding unit 71 of the vCPE 70 decapsulates the packet and registers the connection information in the connection information table 75 (FIG. 8) (S61). Specifically, the forwarding unit 71 registers, in the connection information table 75, the transmission source EID=EID #11 of the original packet after decapsulation, the destination EID=EID #3, and the area ID (area 2) determined from ip #32, which is the destination IP address before the decapsulation.

Subsequently, the forwarding unit 71 searches for the global routing table 73 again (S62). Since the decapsulated packet corresponds to the record of “Destination=EID #3, Processing=Direct” in FIG. 7, the forwarding unit 71 directly delivers the packet to EID #3 (that is, the host 60-3) (S63). As a result, the host 60-3 receives the packet from the host 60-11.

Meanwhile, a flow of a packet from the host 60-3 to the host 60-11 is as illustrated as in FIG. 16.

In step S64, the host 60-3 transmits a packet to the host 60-11 (S64).

When the packet from the host 60-3 is received, the forwarding unit 71 of the vCPE 70 searches for the connection information table 75 first, checks whether the packet is a response packet from the host 60-11 to the host 60-3 (a packet having a transmission source EID and the destination EID in a reversely switched manner), and acquires information regarding the area ID (S65). Here, since the packet corresponds to the record of the transmission source EID=EID #11, the destination EID=EID #3, and the area ID=area 2 registered in step S61, it is possible to ascertain that the packet may be transmitted to the AR 40 (AR 40-2) of the area 2.

The forwarding unit 71 thus refers to the area 2 routing table 74-2 (FIG. 7) (S66). Only the default route is registered in the area 2 routing table 74-2, and processing thereof is Encap (IP #A2). Accordingly, the forwarding unit 71 encapsulates the packet with the destination address=IP #A2 and transmits the packet to the AR 40-2 which is the area representative router of the area 2 (S67).

When the packet is received, the forwarding unit 41 of the AR 40-2 refers to the routing table 43-2 (see FIG. 17) (S68). Since the packet corresponds to the record of “Destination=IP #A2, Processing=Decap->Lookup” in the routing table 43-2 in FIG. 17, the forwarding unit 41 decapsulates the packet and searches for the routing table again. The destination of the decapsulated packet (original packet) is EID #11, and thus corresponds to “Record of Destination=EID #11, Processing=Encap (IP #22)” in the next search. Therefore, the forwarding unit 41 encapsulates the packet with the destination address=IP #22 and transmits the packet to IP #22, that is, the CPE 50-11 (S69).

When the packet from the AR 40-2 is received, the forwarding unit 51 of the CPE 50-11 refers to the routing table 54-11 (S69). Since the packet corresponds to “Destination=IP #22, Processing=Decap->Lookup” in the routing table 54-11 of the CPE 50-11 after the movement in FIG. 17, the forwarding unit 51 decapsulates the packet and searches for the routing table 54-11 again. Next, the decapsulated packet corresponds to the record of “Destination=EID #11, Processing=Direct”, the forwarding unit 51 directly delivers the packet to EID #11, that is, the host 60-11 (S70). As a result, the host 60-11 receives the packet from the host 60-3.

In a case where the CPE 50-11 moves from the position under control of the AR 40-1 to the position under the AR 40-2 in this manner, only the AR 40-1, the AR 40-2, and the CPE 50-11 have changes in the routing tables, and no other changes occur in the routing table of the vCPE 70. This indicates that an increase or decrease in the number of devices 10 or movement of the devices 10 causes no change at all in the routing tables 54 of the vCPE 70 and the vCPE 70 is not affected by the amount of the routing tables or the amount of processing for changing the routing tables.

[Scale-In/Scale-Out of vCPE 70]

The present embodiment can be applied without any problem even to a case where there are a plurality of vCPEs 70 that connect LANs (same EIDs) in the same data center 20. A plurality of records with different RLOCs are present for the same EID and area ID in the EID-RLOC database 33 (FIG. 11) of the controller 30, and the controller 30 can select one of the plurality of vCPEs 70 by selecting one appropriate record (appropriate vCPE 70) randomly or in consideration of load conditions or the like of the vCPE 70 and returning the RLOC related to the record to the CPE 50, from among the plurality of records including the EID and the area ID related to an inquiry when the CPE 50 inquires the RLOC of the vCPE 70 to the controller 30.

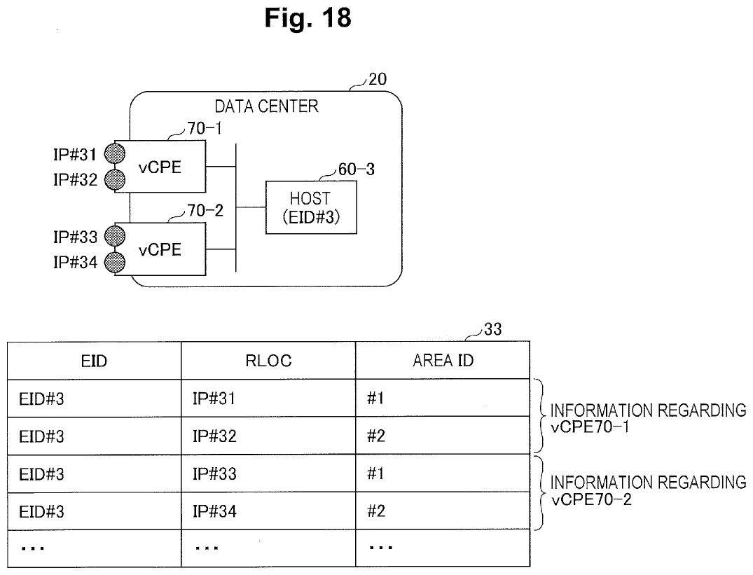

For example, a case where a vCPE 70-1 and a vCPE 70-2 accommodate an area #1 and an area #2 together as in FIG. 18 will be considered. In other words, a case where the data center 20 has the two vCPEs 70, namely the CPE 70-1 and the vCPE 70-2 with the vCPEs 70 of the data center 20 scaled out is illustrated on the upper side of FIG. 18. In addition, the content of the EID-RLOC database 33 of the controller 30 in this state is illustrated on the lower side of FIG. 18.

In this state, it is assumed that an RLOC solution request for (EID=EID #3, AREA ID=#1) is transmitted from the CPE 50 belonging to the area #1 to the controller 30. In this case, once the EID-RLOC database 33 of the controller 30 is searched for with the search key “EID=EID #3, Area ID=#1”, two RLOCs, namely RLOC=IP #31 of the first record and RLOC=IP #33 of the third record are returned. In a case where a plurality of records are searched for, the controller 30 selects one of the records in round robin or at random and returns the RLOC of the record as an RLOC resolution response to the CPE 50. It is thus possible to implement load distribution in which a plurality of vCPEs 70 are selectively used in units of CPEs 50. The same applies to a case where there are three or more vCPEs 70. It is thus possible to implement scale-in/scale-out of the vCPEs 70.

Note that in a case where a plurality of vCPEs 70 are present in the LAN of the same data center 20, a problem that which of the vCPEs 70 the host 60 is to transmit a response packet from the host 60 in the LAN occurs. This can be solved by a method of associating and managing the vCPEs 70 and the host 60, that is, a method in which the host 60-31 provides service to the vCPE 70-1 and the host 60-32 provides service to the vCPE 70-2. Alternatively, in a case where it is desired to use a plurality of hosts 60 in a load distributed manner, a method of performing Source NAT (SNAT) with an address on the LAN side of the vCPE 70 when a packet is transmitted from the vCPE 70 to the host 60 is also considered. Since the transmission source address viewed from the host 60 becomes the LAN side address of the vCPE 70 by performing the SNAT in the vCPE 70, the response packet naturally returns to the original vCPE 70.

[Handling in Case where Only Single IP Address is Assigned to vCPE 70]

Depending on the environment of the data center network in which the vCPE 70 is installed, only one IP address (RLOC) may be allocated to the vCPE 70, and the area cannot be determined by the IP address of the vCPE 70. In such a case, an SID for identifying the area is additionally assigned like (an IP address of the vCPE and an SID for identifying the area of the CPE 50) when encapsulation by SRv6 is performed by the CPE 50. Upon receiving this packet, the vCPE 70 refers to “the SID for identifying the area of the CPE 50” added to the tail end of the SID List, determines the area to which the CPE 50 that is the transmission source of this packet belongs, and adds the connection information to the connection information table 75. In this manner, the vCPE 70 can determine the area to which the CPE 50 belongs even in an environment in which only a single IP address is allocated.

As described above, according to the present embodiment, a single vCPE 70 can process packets from a plurality of areas, and it is thus possible to solve the problem that the vCPES 70 are required in number corresponding to the number of areas regardless of the traffic amount. This enables the vCPE 70 to be flexibly scaled-out and scaled-in in response to an increase or decrease in traffic demand, so that computing resources to be allocated to the vCPE 70 can be used as needed without waste. In other words, it is possible to improve economical efficiency at the time of consolidating an overlay network for each area.

Note that, in the present embodiment, a computer that functions as the vCPE 70 is an example of a communication device. The forwarding unit 71 is an example of a determination unit, a first transmission unit, and a second transmission unit. The connection information table 75 is an example of a storage unit.

Although the embodiments of the present invention have been described in detail above, the present invention is not limited to such specific embodiments, and various modifications and changes can be made within the scope of the gist of the present invention described in the claims.

### REFERENCE SIGNS LIST

10 Device
20 Data center
30 Controller
31 CPE inquiry unit
32 CPE registration/update unit
33 EID-RLOC database
40 AR
41 Forwarding unit
42 CPE connection unit
43 Routing table
50 CPE
51 Forwarding unit
52 RLOC solution unit
53 CPE registration unit
54 Routing table
60 Host
70 VCPE
71 Forwarding unit
72 Registration unit
73 Global routing table
74 Area-specific routing table
75 Connection information table
100 Drive device
101 Recording medium
102 Auxiliary storage device
103 Memory device
104 CPU
105 Interface device
B Bus
N1 Core network

1. A communication device that accommodates a computer connecting to a LAN in a core network, comprising:
a memory; and
a processor coupled to the memory and configured to:
determine an area to which a transmission source of a first packet belongs on the basis of a destination of a second packet once the second packet is received, the first packet being designated to the computer from any one of a plurality of areas, the second packet being obtained by encapsulating the first packet with a destination of any one of a plurality of IP addresses allocated to the communication device for the respective areas;
transmit the second packet to the computer on the basis of the destination of the second packet; and
encapsulate a response from the computer in a third packet with a destination of an IP address of a representative router of the area determined and transmit the third packet.

2. The communication device according to claim 1,
wherein the processor is configured to store, in a storage, a correspondence between an area determined for the first packet and a transmission source and a destination of the first packet; and
the processor is configured to transmit the third packet with a destination of the IP address of the representative router of the area corresponding to the transmission source and the destination of the response in the correspondence stored in the storage.

3. The communication device according to claim 1,
wherein the processor is configured to specify the IP address of the router with reference to a routing table corresponding to the area determined, in the routing table defined for each area.

4. A communication method performed by a communication device that accommodates a computer connecting to a LAN in a core network, the method comprising:
determining an area to which a transmission source of a first packet belongs on the basis of a destination of a second packet once the second packet is received, the first packet being designated to the computer from any one of a plurality of areas, the second packet being obtained by encapsulating the first packet with a destination of any one of a plurality of IP addresses allocated to the communication device for the respective areas;
transmitting the second packet to the computer on the basis of the destination of the second packet; and
encapsulating a response from the computer in a third packet with a destination of an IP address of a representative router of the area determined and transmitting the third packet.

5. A non-transitory computer-readable recording medium storing a program that causes a communication device that accommodates a computer connecting to a LAN in a core network to execute:
determining an area to which a transmission source of a first packet belongs on the basis of a destination of a second packet once the second packet is received, the first packet being designated to the computer from any one of a plurality of areas, the second packet being obtained by encapsulating the first packet with a destination of any one of a plurality of IP addresses allocated to the communication device for the respective areas;
transmitting the second packet to the computer on the basis of the destination of the second packet; and
encapsulating a response from the computer in a third packet with a destination of an IP address of a representative router of the area determined and transmitting the third packet.
